(19) United States
(12) Patent Application Publication
(10) Pub. No.: US 2017/0076304 A1
(43) Pub. Date: Mar. 16, 2017

(54) SPATIAL MODELING AND OTHER DATA ANALYTICS ENABLED ENERGY PLATFORM

(71) Applicant: PowerScout, Inc., Oakland, CA (US)

(72) Inventors: Attila Toth, Piedmont, CA (US); Kumar Dhuvur, Pleasanton, CA (US); Michael Ulin, Oakland, CA (US)

(21) Appl. No.: 15/260,917

(22) Filed: Sep. 9, 2016

Related U.S. Application Data
(60) Provisional application No. 62/217,691, filed on Sep. 11, 2015.

(51) Int. Cl. G06Q 30/02; G06F 17/30; H04L 29/08; G06N 5/04; G06N 99/00

(52) U.S. Cl. CPC G06Q 30/0202; G06N 5/04; G06N 99/005; G06Q 30/0201; H04L 67/10; G06F 17/30598; G06Q 30/0251; G06Q 30/0283; G06Q 50/163

(57) ABSTRACT

Methods and systems are disclosed for identifying consumers likely to adopt a particular clean energy solution (e.g. solar solutions, such as rooftop panels or community solar offerings; electric battery storage; an electric vehicle; electric vehicle charging infrastructure; energy efficient appliances; etc.), which in some instances includes satellite image analysis of buildings used by consumers. In some cases, the methods can include using GIS data (e.g., LiDAR 3D point cloud data) to model roof facet surfaces and the amount of solar energy received by such surfaces. The methods can also include evaluating additional consumer-related data to predict consumers likely to adopt clean energy solutions. In other implementations, methods and systems are described for remotely sizing a particular clean energy solution based upon a user's submission of a particular address. Additional uses of energy-related data are also described.

### CROSS-REFERENCE TO RELATED APPLICATIONS

This application claims priority to and the benefit of co-pending U.S. provisional patent application Ser. No. 62/217,691, titled “Data Analytics Application for Distributed Energy,” filed on Sep. 11, 2015, the disclosure of which is herein incorporated by reference in its entirety.

### TECHNICAL FIELD

This specification relates to the analysis of data (e.g., satellite image data, geographic information system (GIS) data (e.g. LiDAR 3D point cloud data), consumer data, etc.) to provide improved information to energy providers and improved products and services to energy consumers.

### BACKGROUND

Clean energy solutions represent a large and growing portion of the world's energy market, with more and more customers adopting solutions such as solar energy (e.g. rooftop solar panels and/or community solar offerings), electric battery storage, electric vehicle charging, energy efficient appliances, etc. each year. A significant cost for providers of these clean energy solutions is the costs associated with acquiring new customers, which can be challenging given how ingrained much of society is with more traditional energy solutions (e.g., incumbent utilities, gas, oil, etc.) that have been the standard for more than a century.

Currently, most clean solution energy providers acquire new customers through reliance on a combination of door-to-door sales, broad-based digital marketing using keywords, lead generation vendors, and cold calling campaigns. These methods are untargeted and broad-based. Leads generated using such techniques are typically qualified manually, either in person or via telephone questionnaire. Such efforts are generally time-consuming and expensive. In addition, some sources have reported that customer acquisition costs are on the rise due to the fact that the same customer leads are being called upon by an increasing number of providers, creating increased competition for contracts.

Given that many costs are beyond the direct control of most clean energy solution providers (e.g., electricity costs, hardware costs, etc.), it will be crucial to the survival of most providers to reduce their customer acquisition costs to provide more competitively priced products in more geographies, particularly as government subsidies begin to step down.

### SUMMARY

Particular implementations of the subject matter described in this specification can realize one or more of the following advantages. The system can use acquired and publically available information, in conjunction with information derived from machine learning techniques, to identify potential customers with a high propensity to adopt clean energy solutions. The identified potential customers can then be targeted with more focused marketing materials than are currently used. For example, potential and actual customers can be presented with micro-targeted, lifestyle-driven value propositions for adopting clean energy solutions. In some instances, the system can size and price a clean energy solution for a potential customer nearly instantly upon input of an address, e.g., without the need for a sales representative to make an on-site visit. In some implementations, the system can also generate data that enables creditors to better evaluate risk when extending credit for clean energy solutions. In some implementations, the system also predicts allocations of clean energy resources allowing a determination of supply/demand across various locations, which can facilitate a more efficient exchange of resources; for example, through peer-to-peer or peer-to-grid networks.

In general, one aspect of the subject matter described in this specification can be embodied in methods that include the actions of analyzing satellite images of buildings to identify a subset of buildings having a clean energy solution installed; collecting training data related to at least one of (i) the subset of buildings and (ii) consumers that use the subset of buildings; and using the collected data to train a propensity model that predicts whether a potential customer is likely to purchase the clean energy solution. Other embodiments of this aspect include corresponding systems, apparatus, and computer programs.

These and other aspects can optionally include one or more of the following features. The analyzing step can further include: manually inspecting an initial collection of satellite images to identify an initial collection of buildings that have the clean energy solution installed; using the initial collection of buildings to train an image analysis model that determines whether a particular satellite image depicts a building having the clean energy solution installed; and analyzing additional satellite images using the image analysis model to identify the subset of buildings having the clean energy solution installed. In some cases, the method can also include preprocessing the additional satellite images for analysis by the image analysis model, the preprocessing step comprising: (i) cropping a relevant portion of a satellite image, (ii) converting the cropped image into a 3D tensor based on pixel values of the cropped image, and (iii) normalizing the 3D tensor. Normalizing the 3D tensor can include subtracting the average pixel value of the initial collection of satellite images from each pixel in the 3D tensor.

In some implementations, the method can further include obtaining data related to the potential customer; submitting the data as an input into the propensity model; and determining whether the potential customer is likely to purchase the clean energy solution. The data can include at least one of demographic data, credit data, property data, financial data, psychographic data, geographic data, social media activity data, purchase transactions data, 3D point cloud data, electric consumption data, electric tariff data, home energy product and service cost data, and satellite image data. The data can also include an amount of solar energy received by a roof of a building used by the potential customer. In some cases, the method can also include determining the amount of solar energy received by the roof of the building, the determining step comprising: (i) obtaining 3D point data for the building and surrounding objects; (ii) removing points that correspond to points on the ground, (iii) simulating the amount of sunlight received by the roof; (iii) aggregating similar points to model surfaces on the roof; and (iv) aligning the simulated sunlight with the modeled roof surfaces. The 3D point cloud data can be obtained from measurements taken using a LiDAR device (as well as many other sources, as described below). The input data can be obtained from publically available and/or purchased databases.

In some implementations, the method can also include targeting with marketing materials the potential customers determined to be likely to purchase the clean energy solution. The method can also include clustering the potential customers determined to be likely to purchase the clean energy solution based on a criteria related to marketing material preference (e.g., an age, location, and/or credit score of the potential customer). The clean energy solution can include solar panels, an electric vehicle, electric vehicle charging infrastructure, a community solar offering, battery storage, and/or energy efficient appliances.

In general, another aspect of the subject matter described in this specification can be embodied in methods that include the actions of receiving a physical address for a property of a user as an input from the user; remotely obtaining data for at least one of (i) the physical address and (ii) the user; remotely determining a size of a clean energy solution for the property; and providing the user with a price for the clean energy solution. Other embodiments of this aspect include corresponding systems, apparatus, and computer programs.

These and other aspects can optionally include one or more of the following features. In some cases, the remotely obtained data includes estimated electric consumption data. The estimated consumption data can be determined by an electric consumption model having at least one of the following inputs square footage, heating degree days, cooling degree days, age of the property, number of rooms, type of heating system, household income, whether the property has a pool, number of bedrooms, number of children living at the property, type of roof, types of walls, number of stories, size of garage, etc. (many other potential inputs are described below). In other cases, the remotely obtained data includes actual electric consumption data. The clean energy solution can include at least one of solar panels, an electric vehicle, electric vehicle charging infrastructure, a community solar offering, battery storage, and/or energy efficient appliances. In some instances, the method can include providing the user with (i) an estimated cost savings as a result of adopting the clean energy solution, (ii) an estimated amount of an environmental resource preservation as a result of adopting the clean energy solution, and/or (iii) an estimated amount of increase in value of the property as a result of adopting an clean energy solution.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 is a schematic diagram of an example data analysis system used in certain implementations;

FIG. 2 is a schematic diagram of an example module for generating image recognition data;

FIG. 3 is a schematic diagram of an example module for generating electric consumption data;

FIG. 4 is a schematic diagram of an example module for generating GIS data;

FIG. 5 is an example appearance of an address input user interface;

FIG. 6 is an example appearance of a user interface presenting pricing and other information to a user;

FIG. 7 is an example appearance of an electricity bill input user interface;

FIG. 8 is a schematic diagram of an example risk management engine;

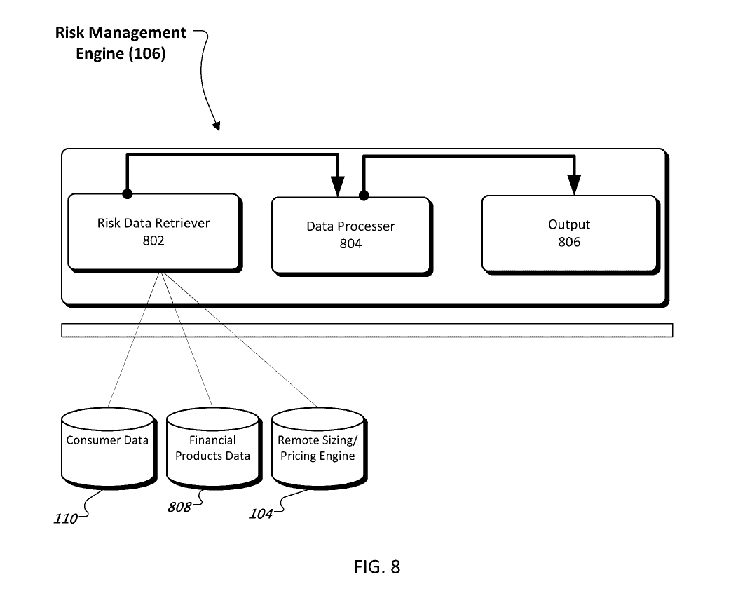

FIG. 9 is an example appearance of a loan approval user interface;

FIG. 10 is an example appearance of a financing options user interface;

FIG. 11 is an example appearance of a risk evaluation information input user interface;

FIG. 12 illustrates an example client device that can be used in certain implementations;

FIG. 13 is a flow chart of an example method of using a propensity engine; and

FIG. 14 is a flow chart of an example method of using a remote sizing/pricing engine.

### DETAILED DESCRIPTION

More data is available in today's information age than ever before. Data can be a powerful analytical tool, but it must be harnessed correctly, which can require identifying data inputs to evaluate and/or model to yield useful outputs. As will be described in detail below, the inventors have developed new data analysis techniques, including the use of unique inputs and models, as a solution to the challenges facing the clean energy industry. This description will often refer to the energy industry and, in particular, the clean energy industry; however, in other implementations, the concepts and inventions described herein can be applied to other industries, as well.

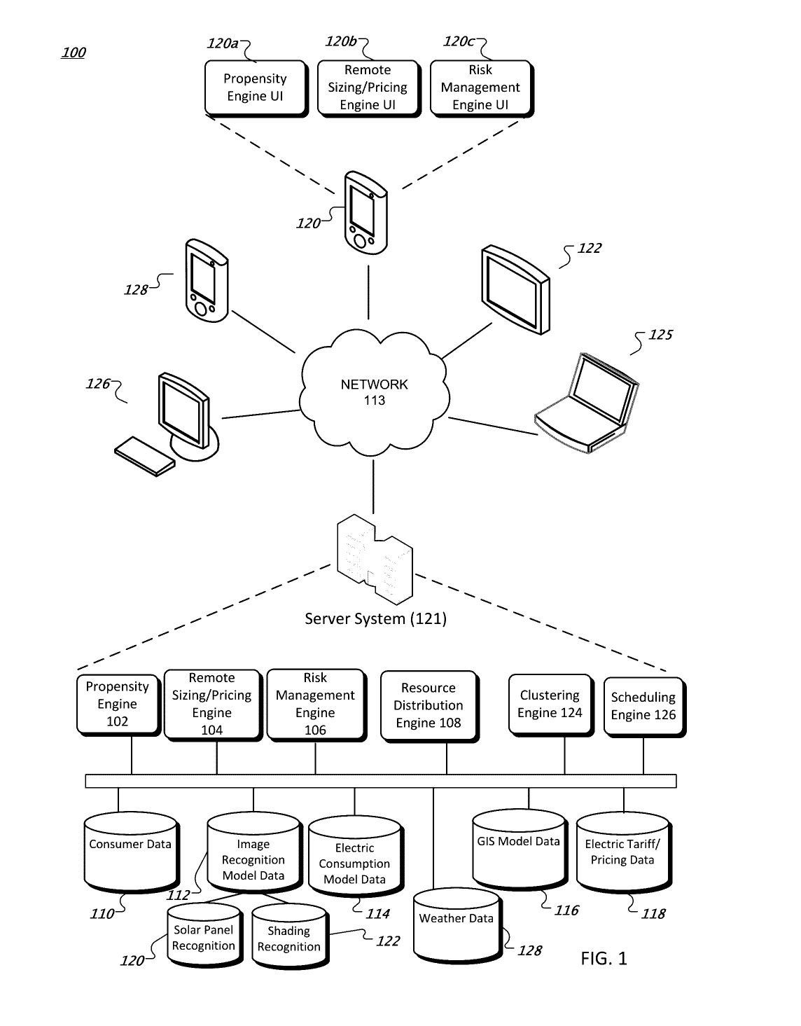

FIG. 1 illustrates an example data analysis system 100. The system 100 is capable of analyzing significant amounts of consumer and energy-related data to produce various outputs useful to energy industry participants. The system 100 comprises hardware components, software components and databases that can be deployed at one or more data centers in one or more geographic locations, for example. In some instances, certain components are hosted on third-party servers (e.g., Amazon Web Services). One or more client devices (e.g., client devices 120, 122, 125, 126 and 128) such as laptop computers, smart phones, tablet computers or desktop computers make requests and receive responses from a server system 121 through network 113. The network 113 can be one or more public or private data communication networks such as the Internet, for example. The communication protocol used by the client devices to communicate with the server system 121 can be HTTP (Hypertext Transfer Protocol) or any other suitable protocol.

In some implementations, each client device contains one or more software components such as a propensity engine user interface (“UI”) 120a, a remote sizing/pricing engine UI 120b, and a risk management engine UI 120c. These components can be implemented as web pages or as stand-alone applications that execute atop operating system software on the client devices. In various implementations, client device UIs are engaged by employees of clean energy providers. For example, the propensity engine UI 120a can display outputs of the propensity engine 102 (described below), which can be of interest to clean energy providers and their employees. In other implementations, the client device UIs are engaged by energy consumers. For example, the remote sizing/pricing engine UI 120b can display outputs of the remote sizing/pricing engine 104 (described below), which can be of interest to energy consumers. In other implementations, the client device user interfaces are engaged by lenders of credit for clean energy solutions. For example, the risk management UI 120c can display outputs of the risk management engine 106 (described below), which can be of interest to energy solution creditors.

In various implementations, the server system 121 components comprise the propensity engine 102, the remote sizing/pricing engine 104, the risk management engine 106, a resource distribution engine 108, a clustering engine 124, and a scheduling engine 126. In various instances, some or all of the engines have the capability to run a large number of derived variables at high processing speeds (e.g., 1 billion rows/hour, 2 billion rows/hour, 3 billion rows/hour, 5 billion rows/hour, 10 billion rows/hour, etc.) The software components can comprise subcomponents that can execute on the same or on different individual data processing apparatus. The software components can also use data drawn from a variety of sources. As one non-limiting example, the server system 121 can include and/or have access to the following databases: a consumer data database 110, an image recognition model data database 112, an electrical consumption model data database 114, a GIS model data database 116, an electric tariff/pricing data database 118, and a weather data database 128, each of which are described in more detail below. The databases can reside in one or more physical storage systems and can be implemented as relational databases, flat files, object-oriented databases, or combinations of these.

In various implementations, the propensity engine 102 executes a propensity model, which generates as an output, a probability that a particular potential customer will adopt a clean energy solution. Among other advantages, the propensity engine 102 can reduce customer acquisition costs by identifying high-quality potential customers with a high likelihood of responding positively (e.g., making a purchase) based on targeted marketing. This can result in less marketing/sales resources being wasted on customers that are less likely to respond positively.

The propensity model is a machine learning model and/or classifier that can generate a probability that a particular potential customer will adopt a clean energy solution (e.g., solar photovoltaic systems, solar water heating systems, electric vehicles, electric vehicle charging, energy storage devices (e.g., batteries), energy efficient heating systems, energy efficient ventilation systems, energy efficient air conditioning systems, energy efficient lighting, energy efficient appliances, etc.). Further description of the model will focus on the propensity model's ability to predict whether a particular consumer will adopt solar solutions; however, this description contemplates the use of similar techniques to predict whether a particular consumer will adopt other energy solutions, as well. Further, the description will primarily focus on the adoption of rooftop solar panels; however, the model can also be used to predict the propensity of consumers to adopt community solar offerings, as well. In some instances, the determined probability can be a score between 0 and 1. Many other outputs are possible (e.g., a percentage, a color code (e.g., red, yellow, green), etc.). In general, the model can be based on any known machine learning model. For example, the model can be: a gradient boosted random forest, a regression, a neural network, a decision tree, a support vector machine, a Bayesian network, etc., as just a few examples. The propensity model can also be based on a Factorization Machine.

In general, the propensity model can use any input that may have some bearing on whether the customer is likely to adopt solar solutions (e.g., rooftop panels, community offerings, etc.). For example, for a particular consumer, the propensity model can use any of the following as inputs, or any combination thereof: number of other homes in the consumer's zip code that have adopted solar, distance to the closest other home that has adopted solar, year the consumer's home was built, per capita income in the consumer's zip code, consumer's electric consumption, population density in the consumer's location, property taxes in the consumer's location, value of the consumer's home, consumer's ethnicity and amount of assimilation of that ethnicity, consumer's land area, size of consumer's property, consumer's credit rating, political donations made by consumer, number of bathrooms in consumer's property, consumer's date of birth, type of air conditioning system used by consumer, type of heating system used by consumer, consumer's length of residence in household, marital status in household, consumer's net worth, presence of kids in consumer's household, consumer's number of active credit lines, number of kids in consumer's household, number of adults in consumer's household, number of family generations in a consumer's household, whether the consumer is a single parent, occupation of the consumer, presence of young adults in consumer's household, presence of a home office in consumer's household, consumer's pet ownership, consumer's home purchase date, consumer's home purchase price, consumer's sewer type, square feet of consumer's living area, square feet of consumer's ground floor, square feet of consumer's basement, weather data (e.g., solar insolation, ambient temperature, humidity, periodicity, intensity of rain, etc.), etc. The input data can, in some cases, be categorized into the following categories: demographic data, credit data, property data, financial data, psychographic data, geographic data, social media activity data, purchase transactions data, etc. Many of the above identified categories of input data are available in publically available databases (e.g., U.S. Census data, Federal Elections Commission data, public real estate data, etc.) and/or for purchase by marketing data vendors. As one illustration of the scale of information available, it has been estimated that residential property databases include at least 1200 attributes for approximately 100 million U.S. homes. Such data can be stored in the consumer data database 110. As described below, other types of input data (e.g., number of other homes in the consumer's zip code that have adopted solar) can be generated using other models (e.g., image recognition model).

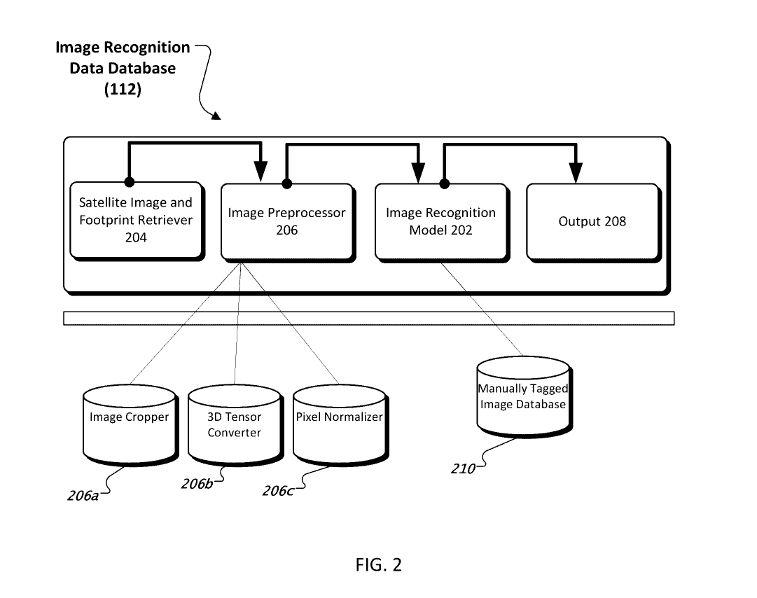

In various instances, the propensity model is trained with data for consumers that are known to have adopted solar and/or known to have not adopted solar. Based on the training set, the propensity model can determine the weights to be accorded to various inputs in determining whether a particular consumer is likely to adopt solar panels. In some instances, in order to acquire the training data set, the system 100 is able to identify buildings that have already adopted solar and those that have not. In some instances, this identification is done using an image recognition model 202, example details of which are shown in FIG. 2.

FIG. 2 provides additional detail as to how the image recognition data in database 112 is generated. In various implementations, the data is generated using an image recognition model 202, which is a model and/or classifier that uses preprocessed satellite images as inputs. The model's output is an indication of a characteristic of the building depicted in the satellite image; for example, whether the building contains solar panels, whether the building is heavily shaded, etc. The model 202 can be trained using manually inspected images. Taking the example where the model 202 identifies buildings that contain solar panels, the training data set can include satellite images that are manually identified as depicting buildings that either contain or do not contain solar panels. In some cases, the images are manually tagged with additional details; for example, if solar panels are present, whether the panels are photovoltaic (PV) panels, water heating panels, or if the building contains both. Such manually tagged images can be stored in a manually tagged image database 210. Once the model 202 is trained, additional satellite images can be input to generate a much larger amount of data.

In some implementations, the image recognition model includes a satellite image and footprint retriever 204. For a particular input address, the retriever 204 can obtain a satellite image of the building located at the address and an outline of the building footprint. In some cases, the image and footprint can be obtained from third-party websites/databases, for example, Google Maps. An image preprocessor 206 can then process the image before it is input into the image recognition model 202. In general, any preprocessing that makes the image suitable for introduction into the image recognition model 202 can be done. Some preprocessing requires modern computing techniques which cannot be accomplished by a human alone. As one example, the preprocessor 202 can: (i) crop the satellite image (using image cropper 206a), e.g. using the building footprint, such that substantially only the building remains; (ii) convert the cropped image into a 3D tensor (using 3D tensor converter 206b), e.g., based on the numerical values of the pixels in the cropped image; and (iii) subtract the average pixel value of the images in the training data set (e.g., manually tagged images in database 210) from each pixel in the 3D tensor. In this example implementation, the resulting preprocessed tensor can be input into the image recognition model 202. The image recognition model 202 can then generate an output 208, which is a prediction of whether the building contains a solar panel or not. This output data can be stored in a solar panel recognition database 120 (see FIG. 1), which can be used by the propensity engine 102, as described below.

Using modern computing techniques, a large number of addresses can be input into the system, resulting in the processing of a large number of satellite images, for example, more than could be done by a human. This effort can generate a data set of properties for which it is known (to a certain degree of confidence, e.g., 80, 90%, 95%, 98%, 99%, etc.) whether a building has adopted solar or not. This information, in conjunction with the data inputs for the propensity modeled detailed above, can be used to train the propensity model, such that eventually the propensity model is able to make predictions regarding whether a particular consumer that has not currently adopted solar panels is likely to do so, based on the characteristics of consumers and buildings that are known to have done so (and in some cases, the characteristics of consumers and buildings that have not). As mentioned, similar techniques can also be used to make predictions regarding whether a particular consumer is like to adopt other clean energy solutions.

In addition to identifying buildings that have adopted solar panels, the data for which can be used to train the propensity model, data generated by the image recognition model 202 can also be used as a direct input to the propensity model. For example, a consumer that has already adopted solar panels would be very unlikely to respond positively to a solar panel marketing campaign (although they may be likely to respond positively to a marketing campaign for other clean energy solutions). Other inputs to the propensity model mentioned above, e.g., number of other homes in the consumer's zip code that have adopted solar and distance to the closest other home that has adopted solar, can also be determined using the image recognition model 202.

In other implementations, the image recognition model 202 can determine even more information that can be used as an input into the propensity model. For example, the model 202 can determine whether a particular building has trees nearby that could cast a shadow on the building's roof, making solar panels impractical. In this example, the image recognition model 202 can be trained with satellite images that are manually identified as either containing trees close enough to a building to cast a shadow on the roof, or not. These manually tagged images can be stored in the manually tagged image database 210.

In such implementations, once the model 202 is trained, upon the input of an address, the satellite image and footprint retriever 204 can obtain a satellite image of the building located at the address and an outline of the building footprint. In some cases, the image and footprint can be obtained from third-party websites/databases, for example, Google Maps. The image preprocessor 206 can then process the image before it is input into the image recognition model 202. As one example, the preprocessor 202 can: (i) crop the satellite image (using image cropper 206a), e.g. using the building footprint, such that substantially only the building remains; (ii) convert the cropped image into a 3D tensor (using 3D tensor converter 206b), e.g., based on the numerical values of the pixels in the cropped image; and (iii) subtract the average pixel value of the images in the training data set (e.g., manually tagged images in database 210) from each pixel in the 3D tensor. In this example implementation, the resulting preprocessed tensor can be input into image recognition model 202. The image recognition model 202 can then generate output 208, which is a prediction of whether the building is surrounded by trees that that could cast a shadow on the property's roof, making solar panels impractical. This output data can be stored in a shading recognition database 122 (see FIG. 1), which can be used by the propensity engine 102. For example, consumers having such properties may not be targeted with marketing materials for solar panels, as they are unlikely to adopt such a solution.

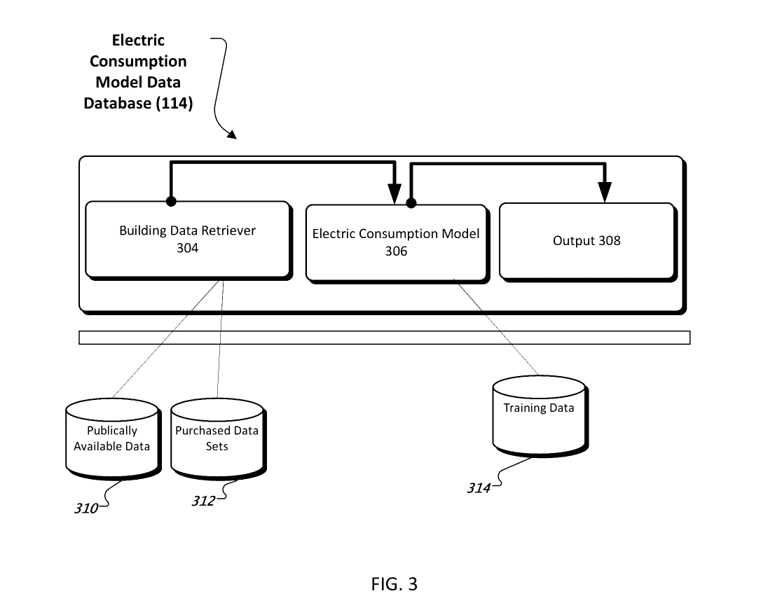

In various implementations, another input to the propensity model of the propensity engine 102 can be electric consumption model data, which may be stored and accessed via database 114. Although the following description will focus on an electric consumption model, in other implementations similar models can be used to predict the consumption of other types of energy. Example details of the electric consumption model are shown in FIG. 3. In general, the electric consumption model can be any model that predicts how much electricity a particular building uses (e.g., in kWH). In some instances, the model is a regression (e.g., Ordinary Least Squares (OLS) regression). In other instances, the model can be a gradient boosted random forest, a neural network, a decision tree, a support vector machine, a Bayesian network, or any other type of model. The model can be trained with any known data linking amount of electricity used to particular buildings. For example, data from consumer electric bills and/or surveys of electric usage. The training data can be stored in a training data database 314.

A building data retriever 304 can obtain property data from either publically available databases 310 or purchased data sets 312 to use as inputs to the electric consumption model. In general, the inputs can be any data that will have some bearing on the amount of electricity consumed by a particular building. For example, any of the following inputs can be used, or any combinations thereof: property square footage, heating degree days, cooling degree days, weather data (e.g., from database 128), age of property, number of rooms, type of heating system, household income, whether there is a pool, number of bedrooms, number of children, type of roof, types of walls, number of stories, size of garage, per capita income in the property's zip code, population density in the property's location, property taxes in the property's location, value of the property, property owner's ethnicity and amount of assimilation of that ethnicity, property's land area, property owner's credit rating, number of bathrooms in property, property owner's date of birth, type of air conditioning system, property owner's length of residence, marital status in household, property owner's net worth, presence of kids in property, property owner's number of active credit lines, number of adults in property, number of family generations living in property, whether the property owner is a single parent, occupation of the property owner, presence of young adults living in property, presence of a home office in property, property owner's pet ownership, property purchase date, property purchase price, property's sewer type, square feet of property's living area, square feet of property's ground floor, square feet of property's basement, etc. The inputs can be input into the electric consumption model 306, which can produce an output 308 predicting the amount of electricity (or other types of energy) consumed by a particular building. As described in more detail below, in some implementations, the electric consumption model 306 can be augmented/adjusted based on a user's actual electricity bill. In some implementations, the electric consumption model 306 can also be adjusted and/or replaced if the system 100 has access to a user's actual electric consumption via a meter (e.g., a smart meter). If such data is available for a particular address, it can be stored in the consumer data database 110. In some cases, smart meter data is evaluated with commercial software, e.g., GreenButton, UtilityAPI, etc.

The output 308 of the electric consumption model 306 can be used as an input into the propensity model to predict whether the consumers using the property may be likely to adopt a particular clean energy solution (e.g., solar panels). As one example, if the building consumes a large amount of energy, that may weigh towards the building's owner being likely to adopt solar panels (as they may save the owner a relatively large amount on an electric bill).

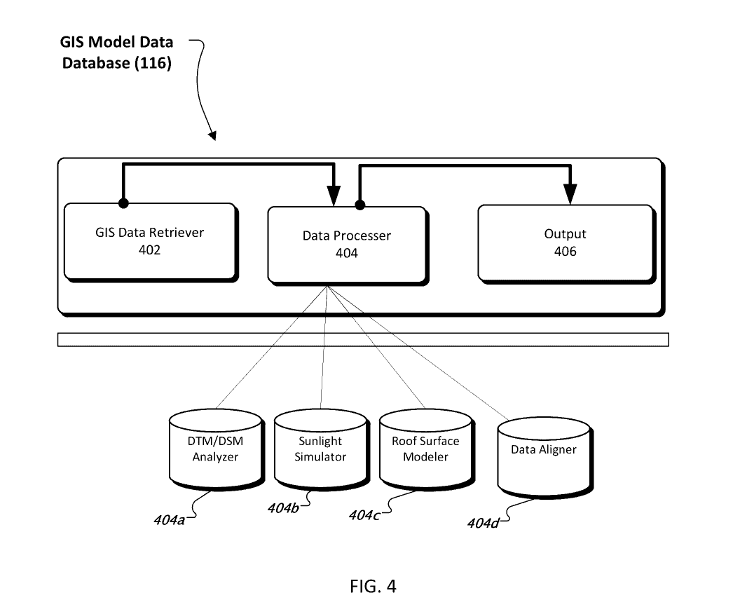

In various implementations, another input to the propensity model of the propensity engine 102 can be GIS model data, which may be stored and accessed via database 116. Example details of the GIS model are shown in FIG. 4. In general, the GIS model can be any model that predicts how much solar radiation a particular building receives. The prediction is generally based on GIS input data and can be based on several factors; for example, the building's size, the building's location, the presence of objects and/or vegetation that could cast a shadow on the property's roof. In general the model can be any type of known predictive model; for example, a gradient boosted random forest, a neural network, a decision tree, a support vector machine, a Bayesian network, or any other type of model. The model can be trained using LiDAR 3D point cloud data, which can be obtained from various public data sources (e.g., the US Geological Survey, the National Oceanic Atmospheric Administration (NOAA), state GIS departments, OpenTopography, the National Ecological Observatory Network, the National Aeronautics and Space Administration, the National Science Foundation's National Center for Airborne Laser Mapping, the United States Interagency Elevation Inventory), as well as from private vendors. The model can be implemented using software offerings such as ArcGIS (from ESRI), QGIS, GRASS GIS, other known GIS offerings, or a custom developed GIS offering.

The model can include a GIS data retriever 402, which acquires GIS data for a particular area of interest. The GIS data can include 3D point cloud data, for example. In some cases, the 3D point data can be acquired from a LiDAR device. In other cases, the 3D point data can be acquired from satellite images. The acquired data can then be processed by data processor 404. In some instances, the data processor 404 can include a DTM/DSM analyzer 404a. The module 404a can separate the GIS data into a Digital Terrain Model (DTM) layer (which is a model of the elevation of the ground in an area) and a Digital Surface Model (DSM) layer (which is a model of the objects on the ground in an area). The module 404a can normalize the DSM layer, by subtracting the DTM layer from the DSM layer, such that the normalized DSM layer is a model of objects on the ground without changes in ground elevation. In some cases, noise from the normalized DSM layer is filtered, e.g., by setting a limit on the height and/or area of objects in the model. The filtered result can be used to generate building footprints.

The processor 404 can also include a sunlight simulator module 404b. Using the normalized/filtered DSM layer data, the module 404b can simulate the amount of sunlight that a particular location receives. For example, the module 404b can take into account the effect that objects located close to a particular building may have on the amount of sunlight the building receives (e.g., if the objects cast a shadow on the building's roof). In some cases, the simulator 404b can also access weather data from database 128.

The processor 404 can also include a roof surface modeler module 404c. The roof surface modeler module 404c can evaluate the slope, aspect, and/or direction of the GIS data. The module 404c can aggregate points with similar nearby points to model surfaces having the same orientation/direction. The modeled surfaces can then be aligned with one another, for example, using software tools (e.g., ArcGIS), to identify surfaces with similar aspect and/or slope. Such identified surfaces can then be clipped from the building footprint data generated by the DTM/DSM analyzer 404a.

The processor 404 can also include a data aligner 404d. The data aligner 404d can align the clipped surfaces generated by the roof surface modeler 404c with the amount of sunlight (solar energy) estimated for a particular location, generated by the sunlight simulator 404b. This alignment provides a prediction for the amount of solar energy that is received on each facet of a particular building's roof. As described in more detail below, this information can be used to generate an output 406 which, in some instances, is an estimate of the maximum amount of solar panels that can fit on a particular roof and/or the yield that such a system would have.

The output 406 can be an input to the propensity model of the propensity engine 102 in determining whether a consumer living in the building would be likely to adopt a solar solution. In some implementations, if GIS data for a particular roof is not available, the data generated by the GIS model can be substituted with other data; for example, marketing vendor data on roof size and data from the U.S. Department of Energy on the amount of solar radiation received by particular locations.

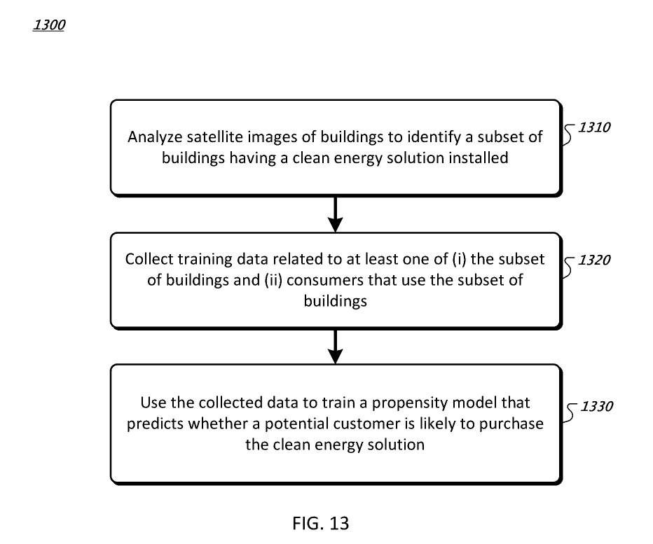

Based on, for example, some or all of the inputs described above (and possibly many others) the propensity model of propensity engine 102 can identify particular consumers that have a higher propensity than other consumers to adopt a clean energy solution such as solar panels. FIG. 13 shows a flow chart of an example method 1300 of using the propensity engine 102. The method can include analyzing satellite images of buildings to identify a subset of buildings having a clean energy solution installed (1310), collecting training data related to at least one of (i) the subset of buildings and (ii) consumers that use the subset of buildings (1320), and using the collected data to train a propensity model that predicts whether a potential customer is likely to purchase the clean energy solution (1330).

The identified customers can then be micro-targeted using a variety of marketing channels, for example, social media, e-mail, banner ads, direct mail, web, mobile, call center, etc. In some implementations, the identified potential customers can be grouped or classified based on a criteria (e.g., age, location, credit, home ownership, etc.) indicative of the consumer's likelihood to respond to a particular marketing technique. As one example, identified potential customers can be grouped based on age; younger potential customers can be targeted with social media marketing, while older potential customers can be targeted with direct mail marketing. Many other examples are possible. In a similar vein, certain identified consumers can be excluded from certain marketing campaigns based on their attributes.

Turning back to FIG. 1, in some implementations, based on the inputs described above (or potentially other inputs), the clustering engine 124 can automatically group the identified consumers into marketing target groups, which in some instances may not have been obvious to a human marketing team. For example, based on its inputs, the clustering engine 124 may determine that there is a strong correlation between consumers that own a pool and active participation in social media. As such, the clustering engine 124 may group all identified potential consumers having a pool into a marketing group that is to be targeted by social media. Many other examples are possible. The clustering engine 124 can execute any clustering model capable of organizing consumers into groups; for example, a k-means or a density based spatial clustering of applications with noise (DBSCAN) model. In some instances, the clustering model is trained similarly to the propensity model, with data for consumers that are known to have adopted a particular solution (e.g., as determined by the image recognition model, or other techniques).

Turning back to FIG. 1, in various implementations, the server system 121 can include a remote sizing/pricing engine 104. Identifying and micro-targeting high value customers that have a high propensity to adopt clean energy solutions can be one component of reducing customer acquisition costs. In some instances, another component can be to quickly provide potential customers with relevant and useful information. Providing such information at a lower cost than conventional techniques provides an even greater advantage. In some instances, the remote sizing/pricing engine 104 accomplishes these objectives.

Conventional techniques for sizing a particular clean energy system (e.g., solar panels) typically include a salesperson making an in-person visit to building of interest in order to observe and measure the building before sizing the system. Alternatively, some providers provide an immediate estimate without the in-person visit, but later adjust it once measurements are taken. Both techniques have disadvantages. An in-person visit cannot be done immediately and requires the potential customer to wait a particular amount of time (e.g., days or weeks) before the system can be sized. In the interim, the potential customer can lose interest and decide not to adopt a particular solution. Additionally, an in-person salesperson must be compensated for the visit. On the other hand, an instant estimate that is later adjusted can also frustrate potential customers causing them to not adopt a particular solution.

In various implementations, the remote sizing/pricing engine 104 provides a solution to the drawbacks of conventional approaches by accurately sizing a clean energy system (e.g., solar panels) from a remote location (e.g., without the need for an in-person visit from a salesperson). The remote sizing/pricing engine 104 can also facilitate a quick and positive experience for the consumer because, as described in more detail below, it can return an accurate price estimate almost immediately after the consumer enters an address. As described below, the remote sizing/pricing engine 104 can also determine and display to the consumer the impact of adopting various clean energy solutions.

In general, the remote sizing/pricing engine 104 executes a remote sizing model, which generates as an output, a size of a clean energy solution (e.g., number of solar panels) for a particular input address. The remote sizing/pricing engine 104 can be interacted with by a consumer using a client device 120b executing the remote sizing engine UI via network 113. The consumer can be, but does not have to be, a customer identified by the propensity engine 102. In some implementations, the UI can permit a user to enter an address for which a clean energy solution is desired. For the sake of example, much of the following discussion will focus on the clean energy solution of solar panels, but similar techniques can be used for other solutions.

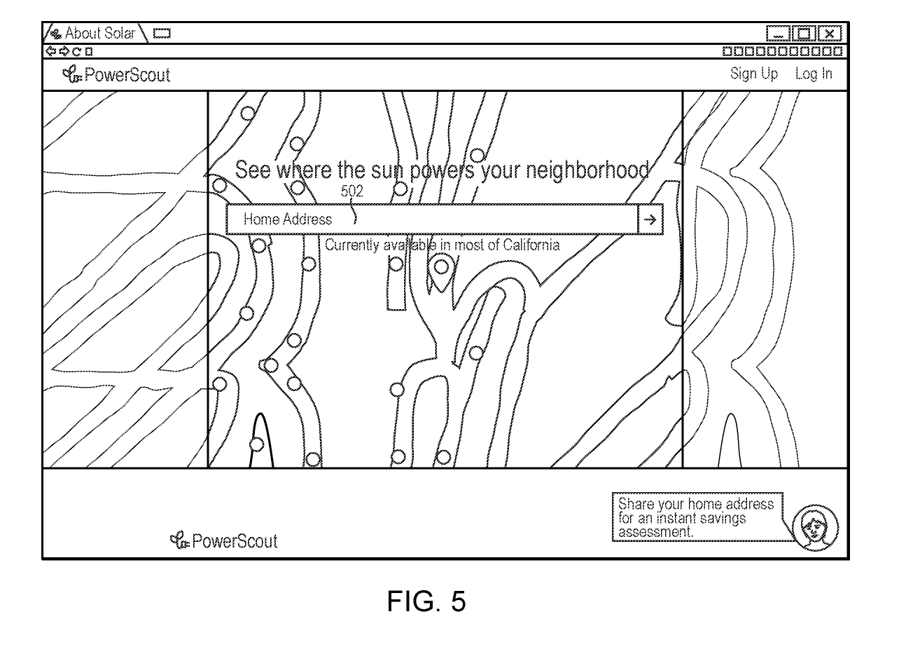

An example UI is shown in FIG. 5. The UI can include a field 502 into which a user can enter an address. Although the example figure says “Home Address,” the address could be for any building, for example, a residential or commercial building. An entered address can be received by the remote sizing/pricing engine 104 (e.g., via network 113). The remote sizing model can access the data generated by the electric consumption model 114 (described above), the GIS model 116 (described above), and/or other inputs, to determine an appropriate size of a solar panel system based on the outputs of these models (as described above).

In various instances, the remote sizing/pricing engine 104 can also access the electric tariff/pricing data database 118. The electric tariff/pricing data database 118 can include any data related to the pricing of clean energy solutions (e.g., solar energy). For example, the costs per energy unit, incentive savings, available financing options, etc. The database 118 can also include data regarding the pricing of clean energy technology systems; for example, average/predicted lifetime of particular systems, average/predicted maintenance costs of particular systems, etc. In some cases, the electric tariff/pricing data 118 can be input into a pricing model along with a size of the proposed system (e.g., generated by the remote sizing model), to remotely calculate the price of a system for the input address. This price can be communicated to the user within seconds of the user inputting the address, and without the need to wait for an in-person sales visit. Further, the user can receive a price by entering only an address, as opposed to additional material, as is typical with conventional pricing techniques.

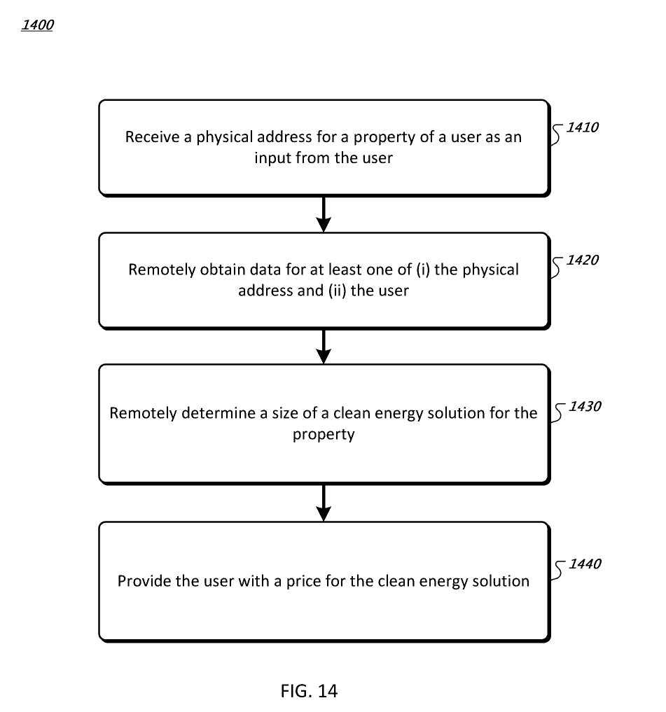

FIG. 14 shows a flow chart of an example method 1400 of using the remote sizing/pricing engine 104. The method can include receiving a physical address for a property of a user as an input from the user (1410), remotely obtaining data for at least one of (i) the physical address and (ii) the user (1420), remotely determining a size of a clean energy solution for the property (1430), and (iv) providing the user with a price for the clean energy solution.

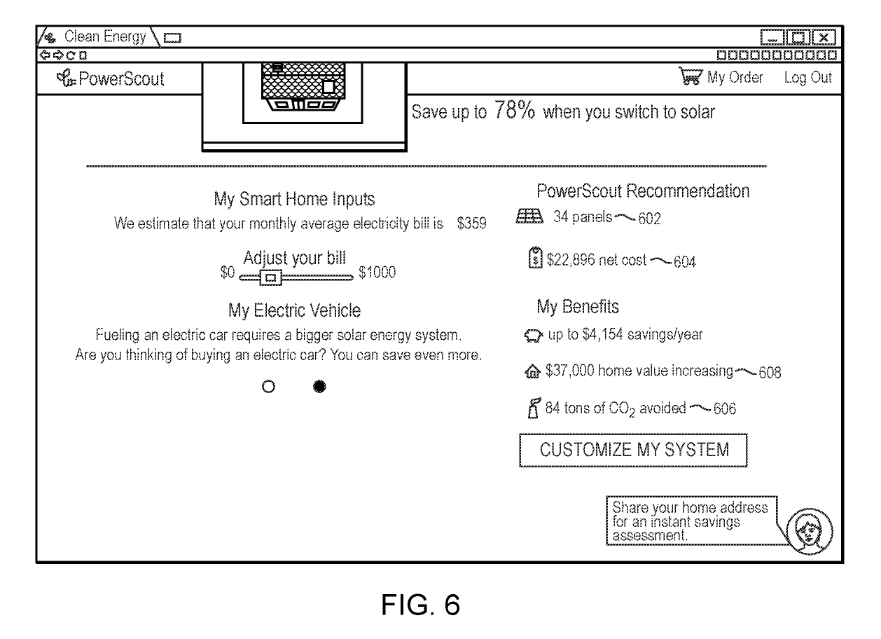

In various implementations, the system 100 can provide a user with additional information of interest, based on the inputs to the system 100 described above. For example, based on the electric consumption model data 114 and electric tariff/pricing data 118, the system 100 can estimate a particular user's savings if they adopt a particular solution. As another example, based on the electric consumption model data 114 and the size of the proposed solution, the system 100 can calculate an amount of a natural resource that may be preserved if the solution is adopted (e.g., pounds of coal that are not burned). As another example, based on the consumer data 110, the system 100 can estimate the amount that a value of a home will increase by adopting the solution. These are just a few of many possible examples. In some instances, the information of interest can be presented to the user in a UI presented on a client device. FIG. 6 shows an example UI providing the user with a system size 602, a cost savings estimate 604 (e.g., over the lifetime of the proposed system), a resource savings estimate 606, and a home value increase estimate 608.

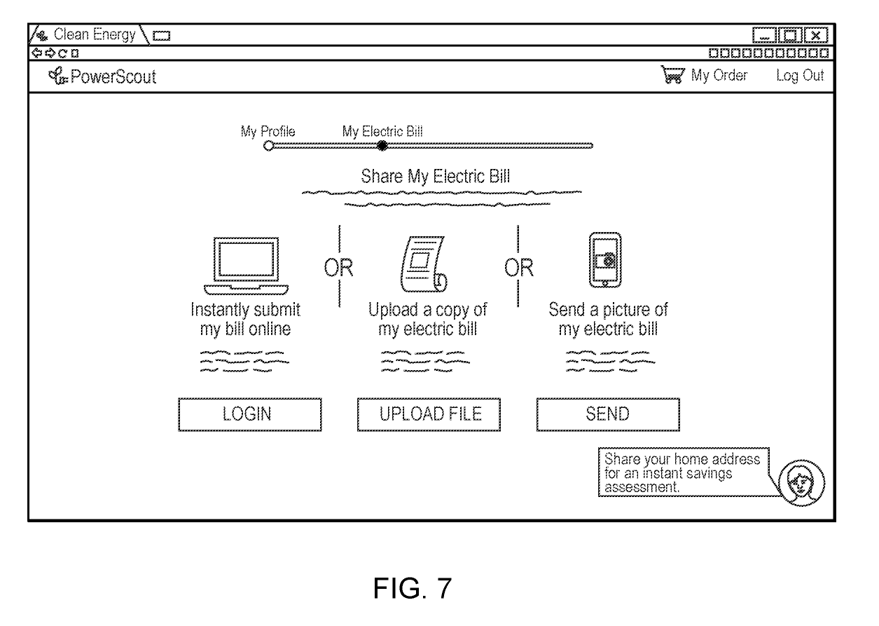

In various implementations, the information provided by the system 100 described above can be adjusted if a user uploads an actual electric bill for the address of interest. For example, the actual electric bill can be input into the electric consumption model 306, which can result in a more accurate estimate of cost savings, resource savings, etc. FIG. 7 shows an example UI that can be presented to a user, providing the option to upload an actual electric bill. As shown, in some cases, the electric bill can be uploaded by sending a photo of the electric bill. In other implementations, the electric consumption model 306 can be adjusted or replaced if an actual measurement of a user's electricity consumption measured by a meter (e.g., a smart meter) is made available to the system 100.

In various implementations, in the event a user actually adopts a particular solution, the system 100 can also receive actual usage data (e.g., from a smart meter made available to the system 100 by the user), and provide real-time updates to the estimated information described above. For example, the system 100 can provide the user with real-time data regarding the cost savings, resource savings, and home value increase, etc., caused by adoption of the clean energy solution. In various implementations, the system can save consumers in a range from $100-$10,000 per year, $500-$1,000 per year, $1,000-$2,000 per year, $2,000-$3,000 per year, $3,000-$5,000 per year, $5,000-$7,500 per year, $7,500-$10,000 per year, etc.

In various implementations, the system 100 can collect timestamp data of when customers actually purchase a clean energy solution. This timestamp data can be used to build a penetration model that predicts the pace at which clean energy solutions are adopted in a particular location. The penetration model can be used as a further determination as to when/how to deploy targeted marketing materials (e.g., along with the outputs of the propensity engine 102 and clustering engine 124). For example, the model may predict critical points of penetration in a particular market (e.g., a spike) that dictates when to deploy particular amounts of marketing materials.

In various implementations, the system 100 can provide a platform through which a consumer can contribute/invest their energy savings. For example, the savings can be contributed to brokerage, retirement savings, college savings, rewards accounts, etc. In some cases, the system 100 can facilitate/streamline the process for the consumer; for example, by providing them with a pre-set-up account. In some cases, the system 100 can provide customers with materials that inform them how the discretionary income from energy savings can be used. In some cases, the materials can be provided to prospective customers as a marketing technique.

Turning back to FIG. 1, in various implementations, the server system 121 can include a risk management engine 106. There are many financial arrangements currently available to consumers to offset (or eliminate) the upfront costs associated with adopting clean energy solutions (e.g., solar solutions). For example, some consumers currently finance the costs for clean energy solutions with loans from lenders. Other consumers take advantage of a Power Purchase Agreements (“PPA”), which generally involves a developer arranging for the financing and installation of a clean energy solution and agreeing to sell power generated from the solution to the consumer at a predetermined cost. Many other arrangements are offered. Many current arrangements involve some risk on the part of the lender/developer/etc. (referred to generically herein as “creditor”). Current techniques for evaluating the risk to creditors of extending credit to a particular customer typically rely on evaluation of a limited number of inputs; for example, the customer's FICO score. The relatively limited information evaluated by these techniques results in certain customers being approved for financing that end up defaulting, as well as other qualified customers being prevented from obtaining financing.

In some implementations, the risk management engine 106 can provide more insight into the risks associated with extending credit, which can result in less risk for the creditors, as well as a larger pool of potential customers for energy solution providers. In general, the risk management engine 106 executes a risk management model, which generates as an output the risk associated with extending credit to a particular potential customer. The output can be anything capable of communicating this information; for example, a number between 0 and 1, a percentage, a color (e.g., green, yellow, red), etc. The risk management engine 106 can be interacted with by a client device 120c (e.g., operated by a creditor) executing the risk management engine UI via network 113.

In some instances, the creditor can enter into the UI 120c the identity of a particular consumer to which it is considering entering into an agreement (e.g., financial loan, PPA, etc.). In some instances, the engine 106 can automatically generate a risk prediction for particular identified consumers (e.g., consumers identified via the propensity engine 102 as being likely to adopt solar solutions). This approach can reduce customer identification costs for creditors. Regardless of how the consumer is identified (e.g., by the creditor, as an output of the propensity engine 102, etc.), the risk management model can evaluate the risk of extending credit (e.g., making a loan, entering a PPA, etc.) to the particular consumer based on any of the inputs described above, which can be retrieved by a risk data retriever 802. For example, the risk management model can have consumer data 110 inputs such as those described above, for example: demographic data, psychographic data, social media data, employment data, insurance data, annual income data, mortgage data, prior delinquencies data, prior bankruptcies data, real estate data (e.g., local vacancies and property values), tax delinquency data, credit rating data, etc. The risk management model can have other financial products data 808 as inputs; for example, real estate products, energy products, consumer credit card products, auto loan products, and business loan products. The risk management engine can also use the size and/or price of a particular solution (e.g., as determined by the remote sizing/pricing engine 104) as an input. A data processor 804 can evaluate these inputs to produce an output 806 which is an indication of the risk of extending a particular amount of credit (e.g., informed by the remote sizing/pricing engine 102) to a particular consumer.

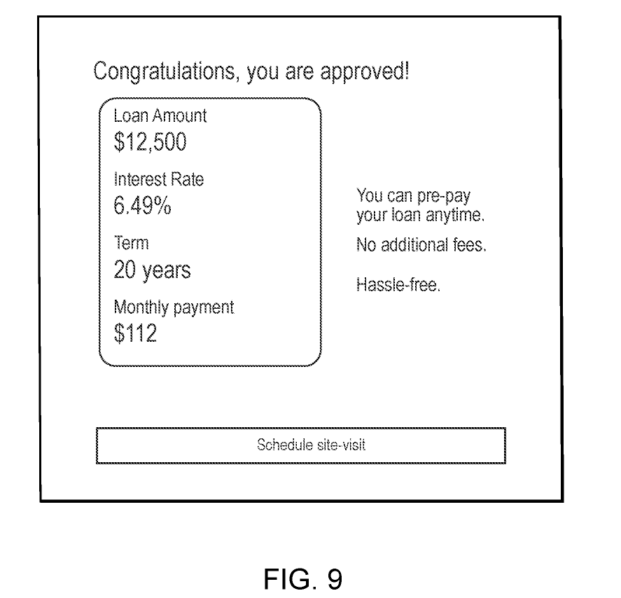

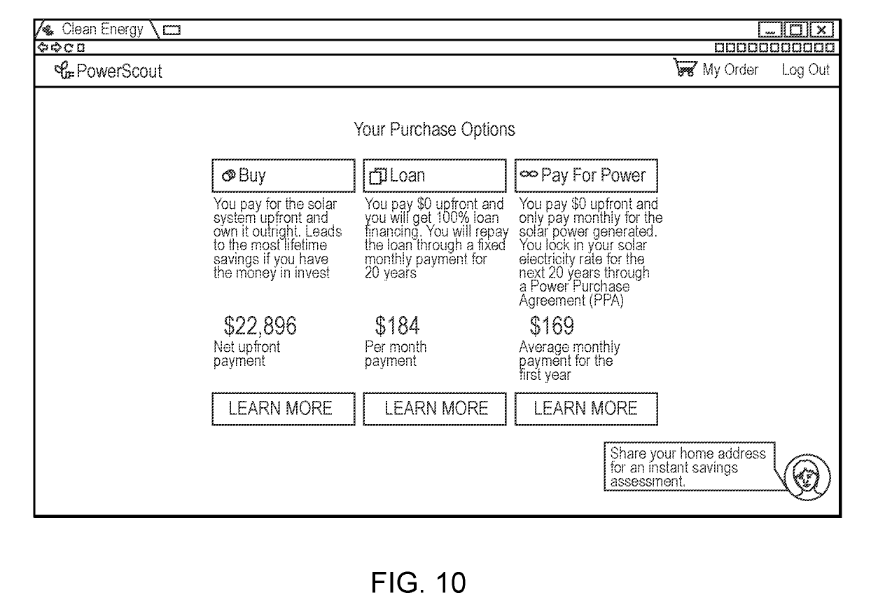

In some instances, the server 121 can communicate the risk associated with taking on a particular consumer to a creditor engaging UI 120c. The creditor can then respond with an approval or rejection based on the risk output 806. In other instances, the server provider and creditors can enter into pre-arranged agreements such that a consumer (e.g., engaging with UI 120b) can be immediately approved and/or denied based on pre-set rules determined by the creditor. In some instances, the creditors can establish specific investment criteria in addition to credit risk; for example, customer type, geography, loan to value, IRR thresholds, contract term, etc. As a result, in some cases, the information presented to a consumer interested in adopting a particular clean energy solution, can include an immediate presentation of financing options. An example of a UI informing a user they have been approved for a loan is shown in FIG. 9. In some cases, multiple options can be presented to the consumer based on various available choices; for example, loan, buy, or pay for power (e.g., under a PPA). An example UI presenting these options is shown in FIG. 10.

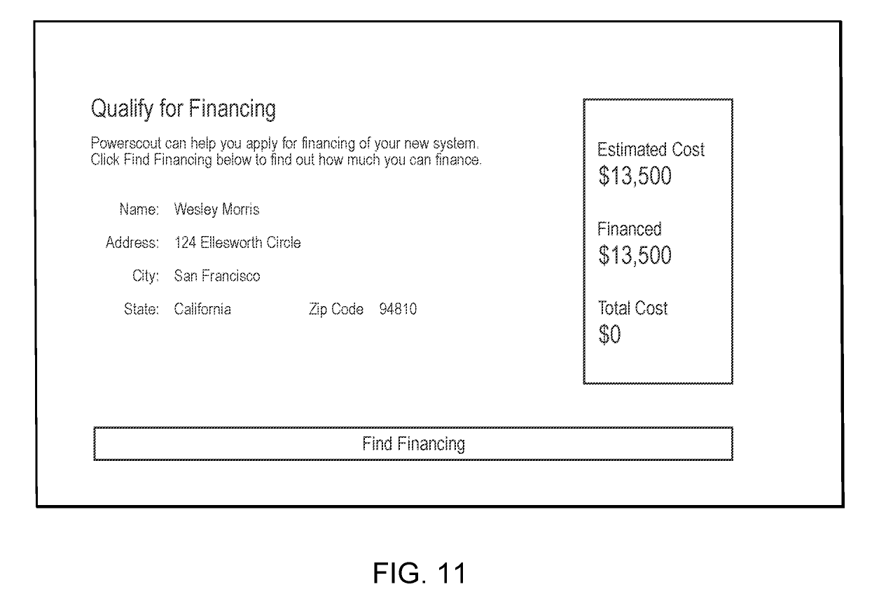

In implementations in which a consumer is already engaged with UI 120b, in addition to or as a substitute to obtaining information regarding the consumer via other channels (e.g., consumer data database 110), the system 100 can request that the user submit certain information to better facilitate a credit check (or, more broadly, a risk evaluation by the risk management engine 106). An example UI requesting this information is shown in FIG. 11.

Turning back to FIG. 1, in various implementations, once a customer decides to adopt a particular solution the scheduling engine 126 can facilitate an installation. The scheduling engine can provide the customer with the ability to select an installation date based on the availability of local installers. In some instances, in addition to accessing and coordinating the installers schedules, the scheduling engine 126 can coordinate various other aspects of the installation, including, but not limited to: obtaining permits, site control documentation, design and engineering management, construction management, interconnection and commissioning, geospatial location, etc. In some instances, the scheduling engine 126 can execute a scheduling model which is trained on input from prior installations. The scheduling model can use any of the input data described above or other types of input data relevant to scheduling. For example, the scheduling model can use weather, traffic, holiday schedules, lead times of particular permitting offices, etc. as inputs.

Turning back to FIG. 1, in various implementations, the system 100 can include a resource distribution engine 108. The following description will focus primarily on the distribution of solar energy, but in other implementations similar techniques can be used for other types of energy. Energy is a commodity that can be distributed via private markets. Certain clean energy resources (e.g., solar energy) are unique from traditional electric energy in that the energy is not generated at a power plant and then distributed to consumers for a fee. Instead, solar energy is collected by consumers on their own property and is dependent upon the amount of sunlight received at a particular location. As a result, certain consumers can end up with excess energy while other consumers do not generate enough (either by a lack of sunlight, lack of equipment to collect the energy, etc.) This naturally creates a supply and demand environment in which a market can evolve between individuals that have excess resources and those that desire additional resources. Various states have adopted rules that allow electricity developed on the properties of consumers to be sold either directly to other consumers or to intermediary companies that find buyers (sometimes as bundles collections of energy acquired from multiple sources).

As mentioned above, in some instances, consumers can provide the system 100 with access to data (e.g., smart meter data) regarding their actual energy collection and usage (e.g., in order to receive real time feedback regarding the effects (e.g., costs savings, resource savings, etc.) of their adoption of clean energy solutions). In some implementations, the resource distribution engine 108 can execute a resource distribution model. The resource distribution model can use smart meter data, along with any of the other inputs described above (e.g., consumer data 110), in conjunction with machine learning techniques, to determine where electrons from various clean energy solutions are location. This determination can allow the system to determine where various energy resources are most and least valuable, and to generate a supply and demand model. In some instances, the supply and demand model can be offered to any entities interested in such data; for example: consumers, utilities, regional transmission organizations, independent system operators, financial service providers, etc. Such data can facilitate effective, and continually improving, peer-to-grid or peer-to-peer energy trading platforms.

### Operating Apparatus

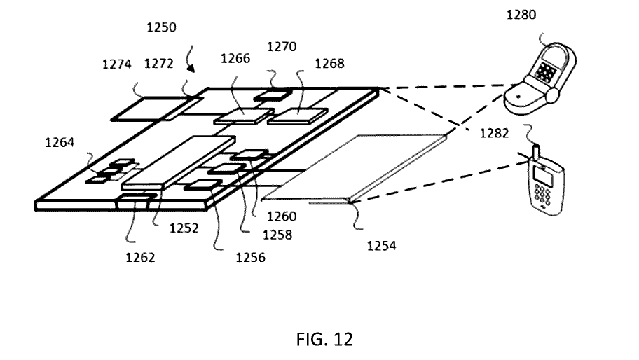

FIG. 12 shows an example of a generic mobile computing device 1250, which may be used with the techniques described in this disclosure. Computing device 550 includes a processor 1252, memory 1264, an input/output device such as a display 1254, a communication interface 1266, and a transceiver 1268, among other components. The device 1250 may also be provided with a storage device, such as a microdrive or other device, to provide additional storage. Each of the components 1250, 1252, 1264, 1254, 1266, and 1268, are interconnected using various buses, and several of the components may be mounted on a common motherboard or in other manners as appropriate.

The processor 1252 can execute instructions within the computing device 1250, including instructions stored in the memory 1264. The processor may be implemented as a chipset of chips that include separate and multiple analog and digital processors. The processor may provide, for example, for coordination of the other components of the device 1250, such as control of user interfaces, applications run by device 1250, and wireless communication by device 1250.

Processor 1252 may communicate with a user through control interface 1258 and display interface 1256 coupled to a display 1254. The display 1254 may be, for example, a TFT LCD (Thin-Film-Transistor Liquid Crystal Display) or an OLED (Organic Light Emitting Diode) display, or other appropriate display technology. The display interface 1256 may comprise appropriate circuitry for driving the display 1254 to present graphical and other information to a user. The control interface 1258 may receive commands from a user and convert them for submission to the processor 1252. In addition, an external interface 1262 may be provided in communication with processor 1252, so as to enable near area communication of device 1250 with other devices. External interface 1262 may provide, for example, for wired communication in some implementations, or for wireless communication in other implementations, and multiple interfaces may also be used.

The memory 1264 stores information within the computing device 1250. The memory 1264 can be implemented as one or more of a computer-readable medium or media, a volatile memory unit or units, or a non-volatile memory unit or units. Expansion memory 1274 may also be provided and connected to device 1250 through expansion interface 1272, which may include, for example, a SIMM (Single In Line Memory Module) card interface. Such expansion memory 1274 may provide extra storage space for device 1250, or may also store applications or other information for device 1250. Specifically, expansion memory 1274 may include instructions to carry out or supplement the processes described above, and may include secure information also. Thus, for example, expansion memory 1274 may be provided as a security module for device 1250, and may be programmed with instructions that permit secure use of device 1250. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 1264, expansion memory 1274, memory on processor 1252, or a propagated signal that may be received, for example, over transceiver 1268 or external interface 1262.

Device 1250 may communicate wirelessly through communication interface 1266, which may include digital signal processing circuitry where necessary. Communication interface 1266 may in some cases be a cellular modem. Communication interface 1266 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 1268. In addition, short-range communication may occur, such as using a Bluetooth, WiFi, or other such transceiver (not shown). In addition, GPS (Global Positioning System) receiver module 1270 may provide additional navigation- and location-related wireless data to device 1250, which may be used as appropriate by applications running on device 1250.

Device 1250 may also communicate audibly using audio codec 1260, which may receive spoken information from a user and convert it to usable digital information. Audio codec 1260 may likewise generate audible sound for a user, such as through a speaker, e.g., in a handset of device 1250. Such sound may include sound from voice telephone calls, may include recorded sound (e.g., voice messages, music files, etc.) and may also include sound generated by applications operating on device 1250.

The computing device 1250 may be implemented in a number of different forms, as shown in FIG. 12. For example, it may be implemented as a cellular telephone 1280. It may also be implemented as part of a smartphone 1282, smart watch, personal digital assistant, or other similar mobile device.

### Operating Environment

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language resource), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending resources to and receiving resources from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
analyzing satellite images of buildings to identify a subset of buildings having a clean energy solution installed;
collecting training data related to at least one of (i) the subset of buildings and (ii) consumers that use the subset of buildings; and
using the collected data to train a propensity model that predicts whether a potential customer is likely to purchase the clean energy solution.

2. The method of claim 1, wherein the analyzing step further comprises:
manually inspecting an initial collection of satellite images to identify an initial collection of buildings that have the clean energy solution installed;
using the initial collection of buildings to train an image analysis model that determines whether a particular satellite image depicts a building having the clean energy solution installed; and
analyzing additional satellite images using the image analysis model to identify the subset of buildings having the clean energy solution installed.

3. The method of claim 1, further comprising preprocessing the additional satellite images for analysis by the image analysis model, the preprocessing step comprising: (i) cropping a relevant portion of a satellite image, (ii) converting the cropped image into a 3D tensor based on pixel values of the cropped image, and (iii) normalizing the 3D tensor.

4. The method of claim 3, wherein normalizing the 3D tensor comprises subtracting the average pixel value of the initial collection of satellite images from each pixel in the 3D tensor.

5. The method of claim 1, further comprising:
obtaining data related to the potential customer;
submitting the data as an input into the propensity model; and
determining whether the potential customer is likely to purchase the clean energy solution.

6. The method of claim 5, wherein the data comprises at least one of demographic data, credit data, property data, financial data, psychographic data, geographic data, social media activity data, purchase transactions data, 3D point cloud data, electric consumption data, electric tariff data, home energy product and service cost data, and satellite image data.

7. The method of claim 5, wherein the data comprises an amount of solar energy received by a roof of a building used by the potential customer.

8. The method of claim 7, further comprising:
determining the amount of solar energy received by the roof of the building, the determining step comprising: (i) obtaining 3D point data for the building and surrounding objects; (ii) removing points that correspond to points on the ground, (iii) simulating the amount of sunlight received by the roof; (iii) aggregating similar points to model surfaces on the roof; and (iv) aligning the simulated sunlight with the modeled roof surfaces.

9. The method of claim 8, wherein the 3D point cloud data is obtained from measurements taken using a LiDAR device.

10. The method of claim 5, wherein the data is obtained from at least one of a publically available database and a purchased database.

11. The method of claim 5, further comprising targeting with marketing materials the potential customers determined to be likely to purchase the clean energy solution.

12. The method of claim 11, further comprising:
clustering the potential customers determined to be likely to purchase the clean energy solution based on a criteria related to marketing material preference.

13. The method of claim 12, wherein the criteria comprises at least one of an age, location, and credit score of the potential customer.

14. The method of claim 1, wherein the clean energy solution comprises at least one of solar panels, an electric vehicle, electric vehicle charging infrastructure, a community solar offering, battery storage, and energy efficient appliances.

15. A system comprising:
one or more computers programmed to perform operations comprising:
analyzing satellite images of buildings to identify a subset of buildings having a clean energy solution installed;
collecting training data related to at least one of (i) the subset of buildings and (ii) consumers that use the subset of buildings; and
using the collected data to train a propensity model that predicts whether a potential customer is likely to purchase the clean energy solution.

16. The system of claim 15, wherein the analyzing step further comprises:
manually inspecting an initial collection of satellite images to identify an initial collection of buildings that have the clean energy solution installed;
using the initial collection of buildings to train an image analysis model that determines whether a particular satellite image depicts a building having the clean energy solution installed; and
analyzing additional satellite images using the image analysis model to identify the subset of buildings having the clean energy solution installed.

17. The system of claim 15, wherein the operations further comprise:
preprocessing the additional satellite images for analysis by the image analysis model, the preprocessing step comprising: (i) cropping a relevant portion of a satellite image, (ii) converting the cropped image into a 3D tensor based on pixel values of the cropped image, and (iii) normalizing the 3D tensor.

18. The system of claim 17, wherein normalizing the 3D tensor comprises subtracting the average pixel value of the initial collection of satellite images from each pixel in the 3D tensor.

19. The system of claim 15, wherein the operations further comprise:
obtaining data related to the potential customer;
submitting the data as an input into the propensity model; and
determining whether the potential customer is likely to purchase the clean energy solution.

20. The system of claim 19, wherein the data comprises at least one of demographic data, credit data, property data, financial data, psychographic data, geographic data, social media activity data, purchase transactions data, 3D point cloud data, electric consumption data, electric tariff data, home energy product and service cost data, and satellite image data.

21. The system of claim 19, wherein the data comprises an amount of solar energy received by a roof of a building used by the potential customer.

22. The system of claim 21, wherein the operations further comprise:
determining the amount of solar energy received by the roof of the building, the determining step comprising: (i) obtaining 3D point data for the building and surrounding objects; (ii) removing points that correspond to points on the ground, (iii) simulating the amount of sunlight received by the roof; (iii) aggregating similar points to model surfaces on the roof; and (iv) aligning the simulated sunlight with the modeled roof surfaces.

23. The system of claim 22, wherein the 3D point cloud data is obtained from measurements taken using a LiDAR device.

24. The system of claim 19, wherein the data is obtained from publically available databases.

25. The system of claim 19, wherein the operations further comprise:
targeting with marketing materials the potential customers determined to be likely to purchase the clean energy solution.

26. The system of claim 25, wherein the operations further comprise:
clustering the potential customers determined to be likely to purchase the clean energy solution based on a criteria related to marketing material preference.

27. The system of claim 26, wherein the criteria comprises at least one of an age, location, and credit score of the potential customer.

28. The system of claim 15, wherein the clean energy solution comprises at least one of solar panels, an electric vehicle, electric vehicle charging infrastructure, battery storage, a community solar offering, and energy efficient appliances.
